(19) United States
(12) Patent Application Publication
(10) Pub. No.: US 2001/0040316 A1
(43) Pub. Date: Nov. 15, 2001

(54) Method of making polyurethane composite materials

(76) Inventor: David M.H. Stewart, Epsom, NH (US)

Correspondence Address: Lawson, Philpot & Persson, P.C., 67 Water Street, Suite 110, Laconia, NH, 03246, US

(21) Appl. No.: 09/903,254

(22) Filed: Jul. 11, 2001

Related U.S. Application Data
(62) Division of application No. 09/428,710, filed on Oct. 28, 1999.

(51) Int. Cl. B29C 39/10

(52) U.S. Cl. 264/469

(57) ABSTRACT

The present invention is a method of making a polyurethane composite. The method includes forming a non-polar material into a predetermined shape and preparing its bonding through plasma treatment. Once the bonding surface has been prepared, the non-polar material is positioned in a mold and liquid precursors of polyurethane are poured into a cavity of the mold such that the liquid precursor of polyurethane is in contact with the bonding surface of the non-polar material. The liquid precursor of polyurethane is then cured to form a polyurethane material that is effectively joined to the bonding surface of the non-polar material to form the polyurethane composite material.

### RELATED APPLICATIONS

This application is a divisional application of U.S. patent application Ser. No. 09/428,710, filed on Oct. 28, 1999, which claims the benefit of U.S. Provisional Application Ser. No. 60/106,115, filed Oct. 29, 1998.

### FIELD OF THE INVENTION

The present invention relates to the field of composites and, in particular, to methods of making composites from cast polyurethane and non-polar materials.

### BACKGROUND OF THE INVENTION

Composites of dissimilar materials, such as metal and plastic, or of hard and soft plastics, have allowed the development of new products that are custom tailored for their specific application. Composite materials may be engineered to have various desirable features like toughness, chemical resistance, and moldability. Achieving strong adhesion between different materials however often requires substantial surface treatments with solvents and chemical coatings that can be both expensive and potentially hazardous. In addition, the adhesion properties of non-polar materials, such as ultra high molecular weight (hereinafter UHMW) polyethylene, Teflon®, Nylon®, Delrin®, and the like, are not affected by chemical surface treatments and have heretofore not been widely utilized, in non-additive form, to form composite materials.

Polyurethane is an extremely versatile engineering material that may be altered, through the use of a variety of pre-polymer formulations, to provide superior chemical and mechanical properties. In addition, polyurethane may be cast and therefore may be made to take on a wide variety of engineering shapes. Finally, polyurethane has excellent adhesion properties and may be adhered to a wide variety of metals and non-metals.

One drawback of polyurethane, however, is the relatively high cost of polyurethane compared to non-polar materials such as UHMW polyethylene. This high cost has led to the use of UHMW polyethylene, and other non-polar materials, in applications where polyurethane would be the preferred choice if it were cost competitive. Such applications include those where relatively large, abrasion resistant, parts are required. The versatility and moldability of polyurethane and the cost effectiveness of non-polar materials, such as UHMW polyethylene, would make a composite of the two materials highly desirable in these applications. Despite this desirability, the poor adhesive properties of non-polar materials has heretofore prevented the utilization of such a combination. Thus, there is a need for a method of bonding polyurethane to a non-polar material that results in a polyurethane/non-polar composite.

For many years, a number of different plasmas have been utilized to prepare various surfaces for bonding. Most notably, plasmas have been extensively employed in the semiconductor industry during the manufacture of silicon wafers during the fabrication of integrated circuits. Other applications include the cleaning of laminated substrates used internally in ball grid arrays prior to encapsulation, and the etching of printed circuit board layers during the manufacture of multi-layer PCB's.

Plasma treatment with energetic ion beams is an attractive alternative for chemical and physical surface modification. The ions break chemical bonds near the surface, thereby making it more reactive for bonding to other materials without changing the properties of the underlying bulk material. Plasmas provide a low temperature environment using electrical energy rather than heat to promote chemical reactions. Plasmas eliminate the dangers and problems associated with cleaning chemicals and are environmentally friendly, with no liquid waste requiring costly disposal. Finally, ion bombardment is a one-step process that requires little or no supervision.

A number of United States patents have issued relating to the use of plasmas to treat surfaces of polymers and the like. However, most of these patents disclose the use of bonding agents, heating and/or high pressure to bond two substantially solid materials, and none teaches the use of a plasma for preparing a bonding surface for casting of a polyurethane directly to the bonding surface. As composites utilizing cast polyurethane are of particular commercial importance, there is a need for a method of manufacturing a composite of a polyurethane and a non-polar material that allows the polyurethane to be cast directly to the bonding surface of the non-polar material

### SUMMARY OF THE INVENTION

The present invention is a method of making polyurethane composites. In its most basic embodiment, the method includes forming a non-polar material into a predetermined shape and preparing its bonding surface through plasma treatment. Once the bonding surface has been prepared, the non-polar material is positioned in a mold and liquid precursors of polyurethane are poured into a cavity of the mold such that the liquid precursor of polyurethane is in contact with the bonding surface of the non-polar material. The liquid precursor of polyurethane is then cured to form a polyurethane material that is effectively joined to the bonding surface of the non-polar material to form the polyurethane composite material.

In an alternative method, the non-polar material is ultra high molecular weight polyethylene, having a roughened bonding surface, that is disposed between two electrodes in a sealed vacuum chamber. A direct current plasma, at a discharge potential of between about 300-700 volts at between about one and ten milliamperes per square centimeter, is then discharged for a period of at least sixty seconds to allow the bonding surface of the ultra high molecular weight polyethylene to be sufficiently modified to allow bonding of the polyurethane. It is preferred that an argon or oxygen atmosphere is disposed within the vacuum chamber, however, in other embodiments nitrogen, ammonia, methane, and helium are disposed within the vacuum chamber during discharge.

In the preferred embodiment, a radio frequency plasma at a discharge potential of about 500 volts, at between about one and ten milliamperes per square centimeter, is utilized for a period of at least three minutes.

In another alternative embodiment, a metallic material is positioned in a predetermined position in the mold, before the step of disposing the liquid precursor of polyurethane in the mold, such that polyurethane effectively joins the non-polar material and the metallic material.

The resulting composite material is made up of a non-polar material against which a polyurethane material is cast. In some embodiments, the composite includes a metallic material cast to the polyurethane to join the metallic material to the non-polar material.

It is an aspect of the invention to provide a method for making a polyurethane composite that allows a polyurethane to be cast upon a surface of an inexpensive non-polar part.

It is a further aspect of the invention to provide a method for making a polyurethane composite that allows a non-polar material to be bonded to a metal.

It is a further aspect of the invention to provide a method of manufacturing a polyurethane composite that does not require the use of chemical cleaners or bonding agents.

It is a still further aspect of the invention to provide a method of manufacturing a polyurethane composite that does not require the application of heat or pressure to the polyurethane to achieve an adequate bond.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a flowchart of the basic embodiment of the method of the present invention.

FIG. 2 is a cross sectional view of one embodiment of a polyurethane composite manufactured in accordance with the method of the present invention.

FIG. 3 is a cross sectional view of a polyurethane composite manufactured in accordance with the method of the present invention in which the polyurethane layer is cast between a non-polar layer and a metallic layer.

FIG. 4 is a cross sectional view of a material-handling panel manufactured in accordance with the method of the present invention in which the polyurethane layer is cast between a non-polar layer and a non-metallic layer.

FIG. 5 is a cross sectional view of another embodiment of a material handling panel manufactured in accordance with the method of the present invention in which the polyurethane layer is cast between a non-polar layer and a metallic layer.

FIG. 6 is a cross sectional view of another embodiment of a material handling panel manufactured in accordance with the method of the present invention.

FIG. 7 is a cross sectional view of a composite sprocket for use with a wastewater rake manufactured in accordance with the method of the present invention.

FIG. 8 is a cross sectional view of a roller manufactured in accordance with the method of the present invention.

FIG. 9 is an isometric view of a composite gasket manufactured in accordance with the method of the present invention.

FIG. 10 is cross sectional view of a multi-layer composite manufactured in accordance with the method of the present invention.

FIG. 11 is an isometric view of a cutting disc manufactured in accordance with the method of the present invention.

FIG. 12 is an isometric view of a composite window manufactured in accordance with the method of the present invention.

FIG. 13 is an isometric view of a spring manufactured in accordance with the method of the present invention.

FIG. 14 is an isometric view of a composite glass handling pad manufactured in accordance with the method of the present invention.

FIG. 15 is a cross sectional view of an antenna manufactured in accordance with the method of the present invention.

### DETAILED DESCRIPTION OF THE DRAWINGS

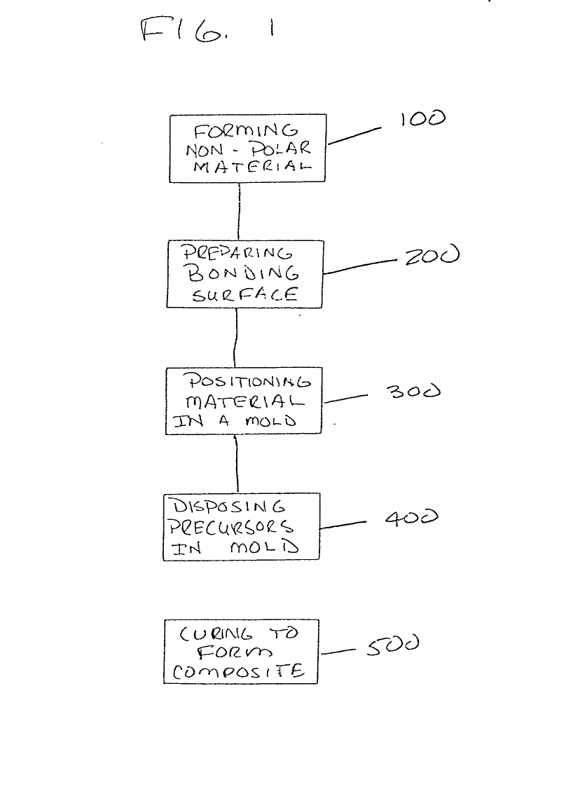

Referring first to FIG. 1, the method of the present invention is described. The method includes the step forming 100 a non-polar material into a predetermined shape and preparing 200 its bonding surface through plasma treatment. Once the preparing step 200, has been completed, the non-polar material is positioned 300 into a mold at a predetermined position such that its bonding surface is adjacent to a mold cavity. Liquid precursors of polyurethane are then disposed 400 into the cavity of the mold such that the liquid precursor fills the cavity created between the non-polar material and the walls of the mold and contacts the bonding surface of the non-polar material. The liquid precursor of polyurethane is then cured 500 to form a polyurethane material that is effectively joined to the bonding surface of the non-polar material to form the polyurethane composite material.

The forming step 100 may be accomplished in many different ways, but preferably is performed by molding the non-polar material and machining to the exact size and surface shape as is required for the particular application. For purposes of the present invention, non-polar materials are defined as materials that do not include positively or negatively charged particles along their surfaces that form reactive sites that allow the materials to bond with charged particles of other materials. Though UHMW polyethylene is the preferred non-polar material, other suitable materials include Nylon®, P.T.F.E. and P.F.A. Teflon®, Delrin®, and the like.

The preparing step 200 involves the use of plasma to create reactive sites about the bonding surface of the non-polar material such that the use of etching chemicals and bonding agents may be eliminated. In a preferred embodiment, plasma is generated in a standard vacuum chamber using commercially available power supplies. The non-polar material is placed between two electrodes in the vacuum chamber, where the plasma density is highest. Processing typically occurs at room temperature (<<100 {C), although the surface temperature may be slightly elevated by immersion in the plasma.

A variety of ambient gases may be utilized during the plasma generation including 15 oxygen, nitrogen, air, argon, ammonia, methane, and helium. Testing has shown, however, that oxygen and argon provide the best bonding surfaces where UHMW polyethylene is utilized. In the former, adhesion enhancement is postulated to be due to the oxygen ions and free radicals generated and, in the latter, due to the long-lived metastable states produced in argon plasma, which are highly energetic. Breaking surface bonds, and even incorporating oxygen atoms in the polymer network serve to enhance subsequent bonding to the isocyanate groups present in polyurethane.

Plasma preparation may be effective over a relatively broad pressure range over which plasma is generated, but ideally, the pressure is between 0.1-0.5 Torr. At lower pressures, there are not sufficient number densities of energetic particles, while at higher pressures, the particles generated do not contain sufficient energy. In the preferred embodiment utilizing O₂ as the plasma gas, the plasma is generated at a substantially constant pressure of 0.4 Torr.

Testing has shown that both radio frequency (RF) (13.56 MHz) and DC discharges may be successfully utilized. RF plasma is more stable, but the electric field moves electrons around in the plasma rather than the ions. This results in slightly longer processing times (˜3 minutes) compared to DC processing. In the case of RF, the discharge potential is preferably about 500V at a current of about a few milliamps/cm2, with a total power of approximately 300 Watts. In the case of DC, between 300-700 V (depending on the pressure) and currents of a few milliamps/cm2 produced a breakdown with a visible plasma glow. Under these conditions, sufficient surface modification occurred to observe enhanced bonding with as little as 60 seconds processing time.

Further testing of each of these systems has revealed that RF plasma systems are preferable to DC plasma systems. This preference is due to the fact that RF systems are more stable and less prone to arcing than DC systems, due to fact that the electric potential oscillates at a high frequency, and because RF instruments oscillating at 13.56 MHz are readily available from commercial vendors. One such suitable RF instrument is model PX-250 produced by March Instruments, of Mountain View, Calif.

The preferred preparing step 200, utilizing RF plasma, begins by roughing a surface of the non-polar material to be prepared. This surface roughing is typically conducted using emery cloth or a belt sander and is intended to increase the surface area and consequently the number of reactive sites upon the surface of the non-polar material. The material is then sealed within a vacuum chamber at a predetermined point adjacent the RF generator and the chamber is evacuated by a vacuum pump to a pressure of approximately 90 mTorr. Oxygen gas is then allowed to enter the chamber until the pressure within the chamber reaches approximately 600 mTorr. The vacuum pump then proceeds to lower the pressure within the chamber to approximately 400 mTorr and is controlled coincidental to the inflow of O₂ such that a substantially constant pressure of 400 mTorr is maintained. The RF generator is then energized at approximately 300 Watts of power and oscillates at a frequency of approximately 13.56 HZ for approximately three minutes. The RF generator is then de-energized, the chamber is purged with a suitable purge gas, such as nitrogen, and the prepared material is removed from the chamber. In cases where the prepared materials are to be used within twenty-four hours of preparation, no special storage procedures need be undertaken. In cases where more than twenty-four hours will elapse, it is preferred that the prepared parts be stored in bags made of Teflon® or another non-polar material.

Once the non-polar material is prepared 200, it is positioned 300 within the mold. A variety of molds may be utilized, but preferably standard molds utilized during polyurethane manufacturing are used. Such molds include open cavity molds, compression molds, transfer and vacuum transfer molds, centrifugal molds, injection and reaction injection molds.

In the preferred embodiment, a mold release compound, such as silicone, is disposed upon the mold walls of the mold to prevent the polyurethane from adhering to the mold walls. However, in other embodiments the mold walls are coated with a non-polar material, such as PTFE or PFA Teflon® or UHMW polyethylene, that is not prepared utilizing a plasma and, therefore, will not adhere to the polyurethane during molding.

Once the non-polar material is positioned 300 within the mold, the liquid precursors of polyurethane are disposed 400 in the mold cavity between the non-polar material and the mold walls. This disposing step 400 may involve pouring, injecting or other means of disposal within the mold cavity, provided that there is proper mixing and set-up of the liquid pre-cursors of polyurethane. For purposes of the present invention, polyurethane means any polymer formulation that includes polyurethane as its principal component, and may include mixtures of polyurethane with additives of polar and non-polar materials.

Once the liquid precursors of polyurethane are disposed 400 within the mold cavity, they are cured 500 to form hardened polyurethane, in the shape of the cavity of the mold, bonded to the bonding surface of the non-polar material. The curing step 500 is performed in accordance with the procedures set forth by the manufacturer of the precursors of polyurethane and, therefore, will vary depending upon the particular polyurethane formulation utilized. Accordingly, in many embodiments this curing step 500 will involve maintaining the mold at an elevated temperature for a predetermined time period and then allowing the polyurethane to fully cure over time to its maximum mechanical properties. In other embodiments, however, the polyurethane is simply allowed to cure at room temperature for a period sufficient to allow the polyurethane to fully cure.

In one embodiment of the method, a metallic material is included in the composite and is attached to the polyurethane opposite the non-polar material. In these embodiments, the metallic material has its surface prepared using conventional techniques and is subsequently positioned at another predetermined position within the mold cavity prior to the pouring step 400. In this manner, a polyurethane composite is formed utilizing the polyurethane as, essentially, an adhesive layer that acts to join together the non-polar material and the metallic material.

In still another embodiment of the method, a second non-metallic member is formed and is included at a different position within the mold. In some embodiments, the identical non-polar material is utilized for the second non-metallic member, while in other embodiments, different non-polar, polar, or other non-metallic materials may be utilized. In each of these embodiments, however, the second member is formed and has its bonding surface prepared in a manner suitable for the particular material. Once this step is completed, the second member is positioned within the mold and processed in the same manner as the metallic material of the metallic embodiment.

As noted above, testing of a variety of composites manufactured in accordance with the method of the present invention was conducted. This testing, undertaken by the University of New Hampshire pursuant to a research agreement with the inventor, confirms that the preparing step 200 provides enhanced adhesion of cast polyurethane to non-polar materials. The results of this research were published in December of 1998 in a paper titled “SURFACE MODIFICATION OF ULTRA HIGH MOLECULAR WEIGHT POLYETHYLENE BY LOW ENERGY DC PLASMA DISCHARGE”, by M. S. Hargreaves, D. S. Hussey and R. E. Leuchtner, of the University of New Hampshire Department of Physics. MRS, Volume 544, Symposium Proceedings, Fall 1999; Plasma Deposition and Treatment of Polymers. This paper, incorporated herein by reference, is intended to provide a basis for the inventors claims of enhanced adhesion and is not intended to limit the scope of the preparing step 200 to the materials or procedures set forth herein.

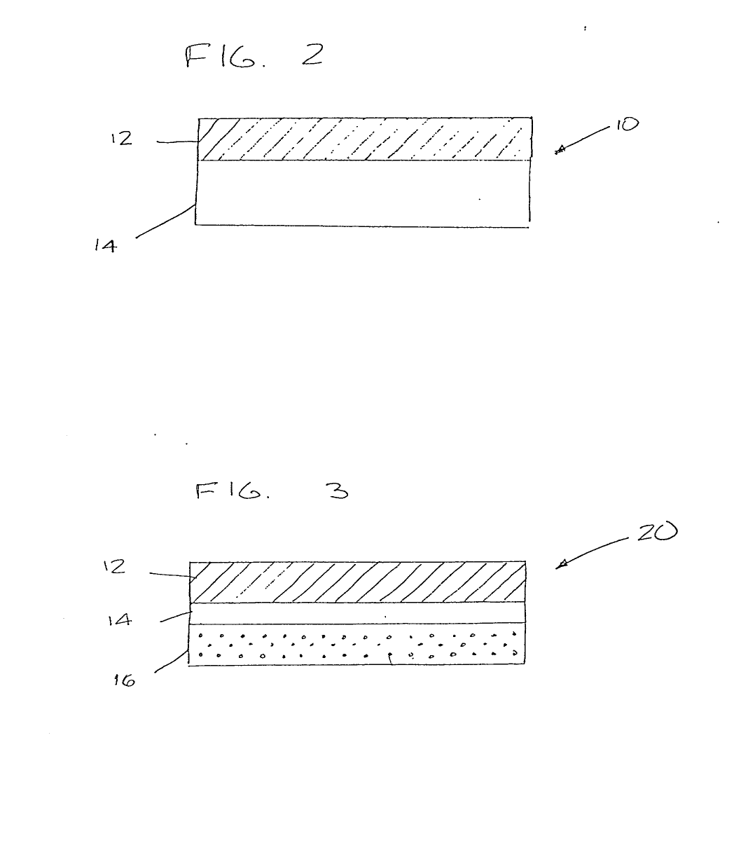

Referring now to FIG. 2, a cross sectional view of one embodiment of the polyurethane composite of the present invention is shown. In this embodiment, the polyurethane composite 10 is formed in the shape of a rectangular sheet with a non-polar layer 12 of a non-polar material bonded directly to a polyurethane layer 14 of a predetermined polyurethane. As noted with respect to the method of the present invention, the polyurethane layer 14 may be of a variety of formulations and may be in the form of a dense solid or cellular foam. Polyurethane composite 10 preferably does not include any adhesives or other chemical bonding agents, but rather relies upon the bonding of the polyurethane layer 14 directly to the bonding surface of the non-polar layer 12. However, the surface preparation step also enhances the adhesion of bonding agents to the surface and, therefore, some alternative embodiments utilize such bonding agents in order to enhance the mechanical properties of the composite 10.

Referring now to FIG. 3, a cross sectional view of a polyurethane composite 20 of the present invention is shown in which the polyurethane layer 14 is cast between a non-polar layer 12 and a metallic layer 16. As shown in FIG. 3, the polyurethane layer 14 is sandwiched between a rectangular non-polar layer 12 and a rectangular metallic layer 16, acting as an adhesive between the layers 12, 16. However, in other embodiments, the non-polar layer 12 and metallic layer 16 are formed into different shapes and are disposed in non-parallel relation to each other to achieve the objectives of the given application. In the preferred embodiment, the metallic layer 16 is made of steel, stainless steel, aluminum, titanium, or magnesium. However, other metallic materials that are commonly bonded to polyurethane may also be utilized to achieve similar results.

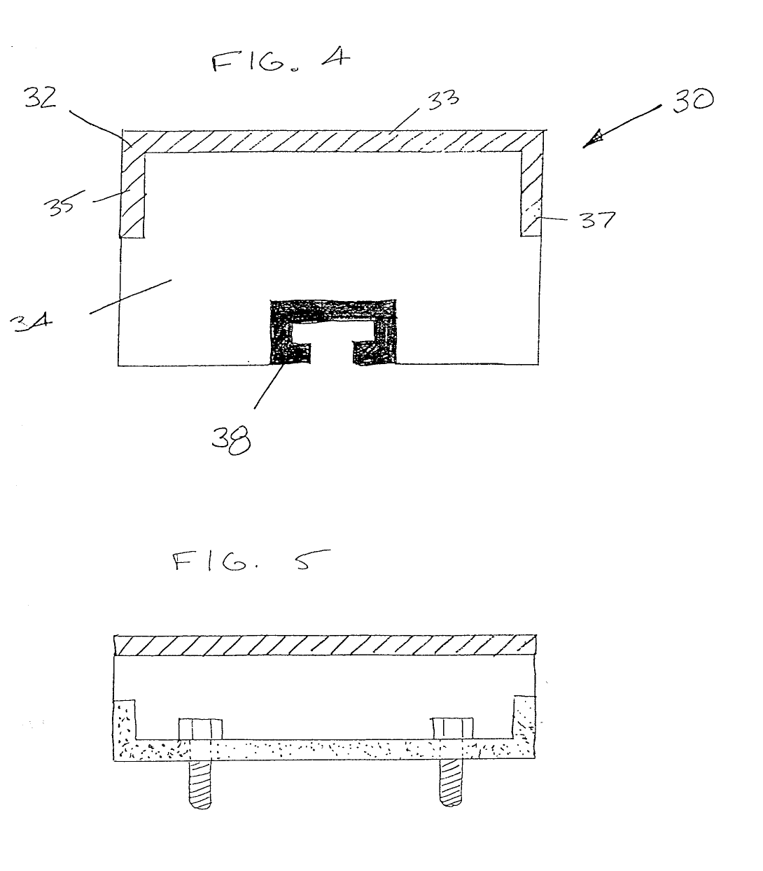

Referring now to FIG. 4, a cross sectional view of a polyurethane composite 30 of the present invention is shown in which the polyurethane layer 34 is cast between a non-polar layer 32 and a non-metallic layer 38. In the embodiment of FIG. 4, the composite 30 is not simply a rectangular sheet, but is formed in a specific shape for use in the material handling industry. The non-polar layer 32 is formed into the shape of a cap having a top surface 33 and a pair of opposed side surfaces 35, 37. A non-metallic layer 38 is formed into a channel to allow the composite to be attached to standardized t-slot type fasteners and is attached to the non-polar layer 32 by the polyurethane layer 34. In this embodiment, it is preferred that the polyurethane layer 34 be a layer of cellular foam polyurethane, but relatively dense layers may be substituted in different applications to achieve similar results.

Referring now to FIG. 5, a cross sectional view of another material handling panel 40, made from the polyurethane composite of the present invention, is shown. In this embodiment, a top layer 42 of a non-polar material is attached to a metallic mounting plate 46 via a layer of polyurethane foam 44. A plurality of mounting bolts 45 are disposed through the mounting plate 46 and encapsulated within the polyurethane layer 44 to allow the mounting plate 46 to be fastened to a frame or other support member (not shown).

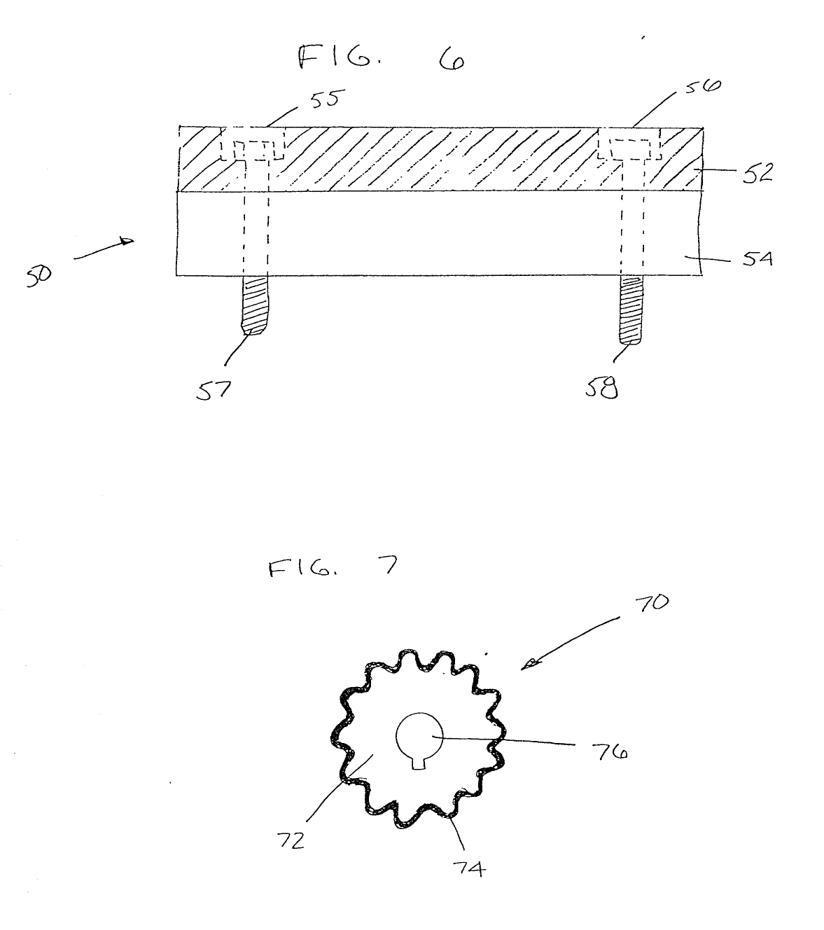

Referring now to FIG. 6, still another material handling panel 50 manufactured from a composite of the present invention is shown. In this embodiment, only a non-polar layer 52 and polyurethane layer 54 are included. However, the non-polar layer 52 includes a plurality of counterbored holes 55, 56 through which mounting bolts 57, 58 are disposed. This arrangement allows the panel to be secured to a surface without the need for another layer of a metallic or non-metallic material for fastening.

It is noted that the shapes and materials utilized in the material handling panels of FIGS. 4-6 may vary depending upon the application. For example, in some embodiments, a metallic channel may be substituted for the non-metallic channel 38 of FIG. 4, or a non-metallic mounting plate may be substituted for the metallic mounting plate 46 of FIG. 5. Thus, the only limitation on the arrangement of such a material handling panel is that there be a non-polar material attached to a layer of polyurethane and that there be some means for securing the panel to a frame or other supporting structure.

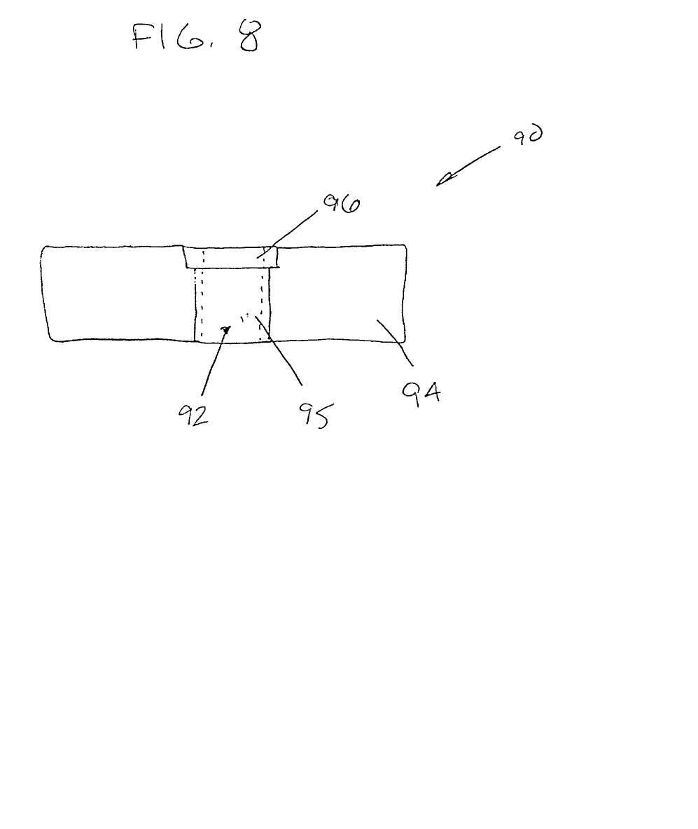

The present invention has applicability far beyond the area of material handling, however, and is intended to cover a variety of applications in which a composite of a non-polar material and polyurethane would be advantageous. Referring to FIG. 7, one such application is shown. FIG. 7 is a cut away top view of a sprocket for use in the movement of sludge rakes in wastewater treatment plants. Typically, these sprockets are subjected to heavy wear along the sprocket surfaces and thus are either made of metal coated with polyurethane or are made entirely of polyurethane. In accordance with the present invention, a core portion 72 of sprocket 70 may be manufactured of a low cost non-polar material and then coated with a layer of polyurethane 74 along the wear surfaces to lower the overall cost of the sprocket. In such an embodiment, spindle opening 76 is dimensioned such that said sprocket 70 will withstand the forces exerted by the rake assembly. It is noted that the same concept would apply to other similar products, such as impellers, pumps and the like that commonly utilize a polyurethane coating for enhanced abrasion resistance. It is also noted that all of the surfaces of the core portion 72 may be prepared such that the polyurethane 74 is made to encapsulate the entire core portion 72.

Referring to FIG. 8, another application for the composite of the present invention is shown. In this application, a non-polar spindle 92 is coated with a layer of polyurethane 94 to form a roller 90. In the preferred embodiment of this application, the spindle 92 is manufactured from Nylon® and includes a cylindrical hub 95 and a flange 96. However, in other embodiments, flange 96 is eliminated. A layer of polyurethane 94 is disposed about the circumference of the hub 95 such that a roller 90 of substantially uniform diameter is formed. By utilizing a nylon spindle 92 instead of a machined or stamped metal spindle, a polyurethane coated roller 90 may be manufactured having superior chemical resistance at a lower cost than those having metal spindles.

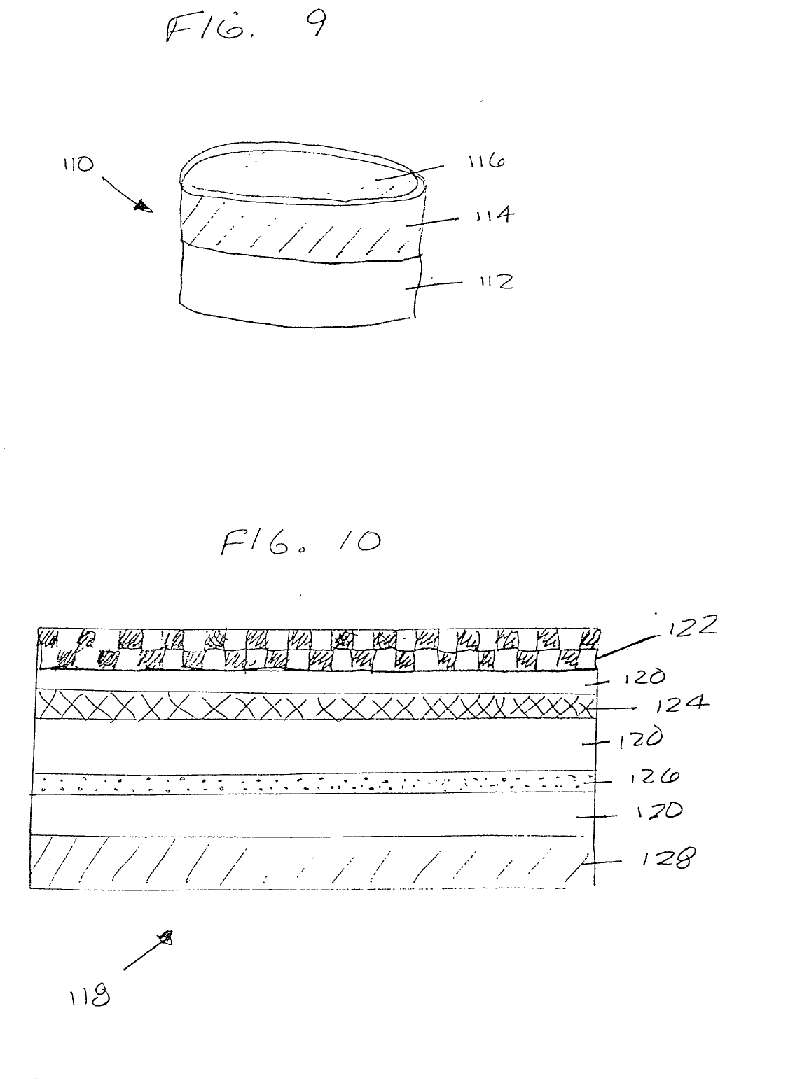

Referring now to FIG. 9, another application for the composite of the present invention is shown. In this application, a composite gasket 110 is formed from a ring of non-polar material 114, such as PTFE Teflon®, upon which is cast a mating ring of polyurethane 112. As shown in FIG. 9, this results in a substantially circular ring having an opening 116 through its center. However, it is understood that gaskets 110 of other shapes and sizes may be manufactured in a similar manner to achieve similar results.

Referring now to FIG. 10, another application for the composite of the present invention is shown. In this application, a composite 118 is made Lip of multiple layers of polyurethane 120 which are cast between layers of different materials 122, 124, 126, 128 in order to join these layers together. As depicted in FIG. 10, layer 128 is a non-polar layer, layer 126 is a metal layer, layer 128 is a rubber layer 124, and layer 122 is a wood layer. However, layers 122, 124, 126, 128 may be arranged in other orientations depending upon the particular application in which the composite is to be utilized. Similarly, different types of polyurethane, i.e. open cell foam, closed cell, etc., may be used in each of the polyurethane layers 120. A composite 118 of this type would be suitable for use as a forge pad or in any other art recognized application in which such composites are currently employed.

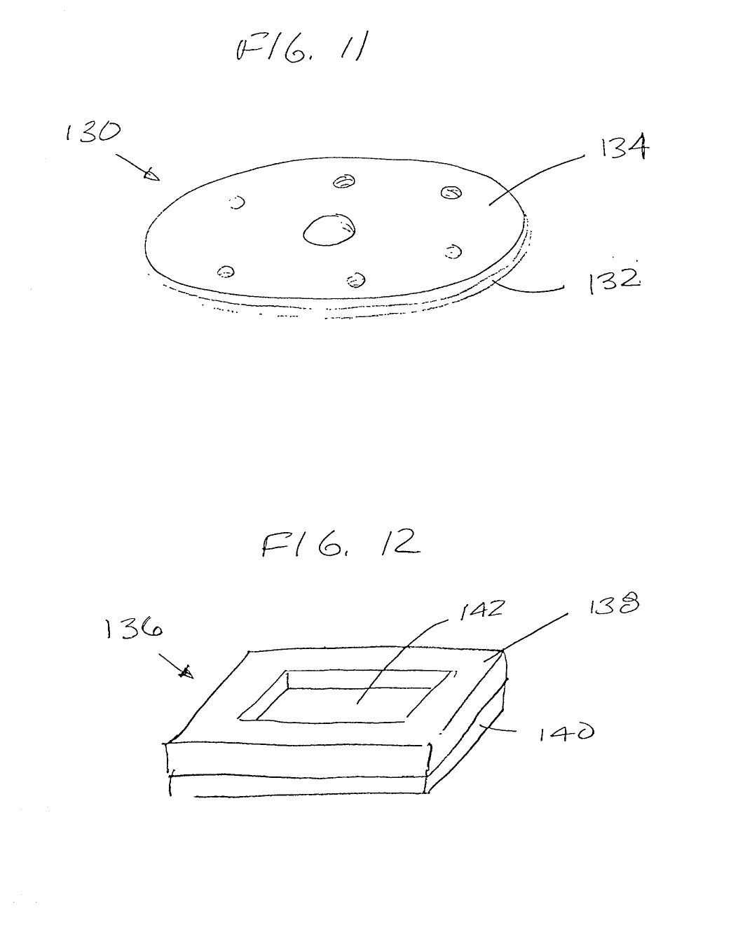

Referring now to FIG. 11, another application for the composite of the present invention is shown. In this application, a composite cutting disk 130 is formed by casting a layer of polyurethane 132 to a substantially rigid layer of non-polar material 134. Such a cutting disk 130 may be used to enhance the performance over current polyurethane cutting disks used in the manufacture of plastic bags and the like. In these applications, the rigidity of the non-polar layer 134, preferably UHMW, serves as a backbone for the polyurethane layer 132 and prevents deflection that can occur once a portion of the polyurethane layer is worn away.

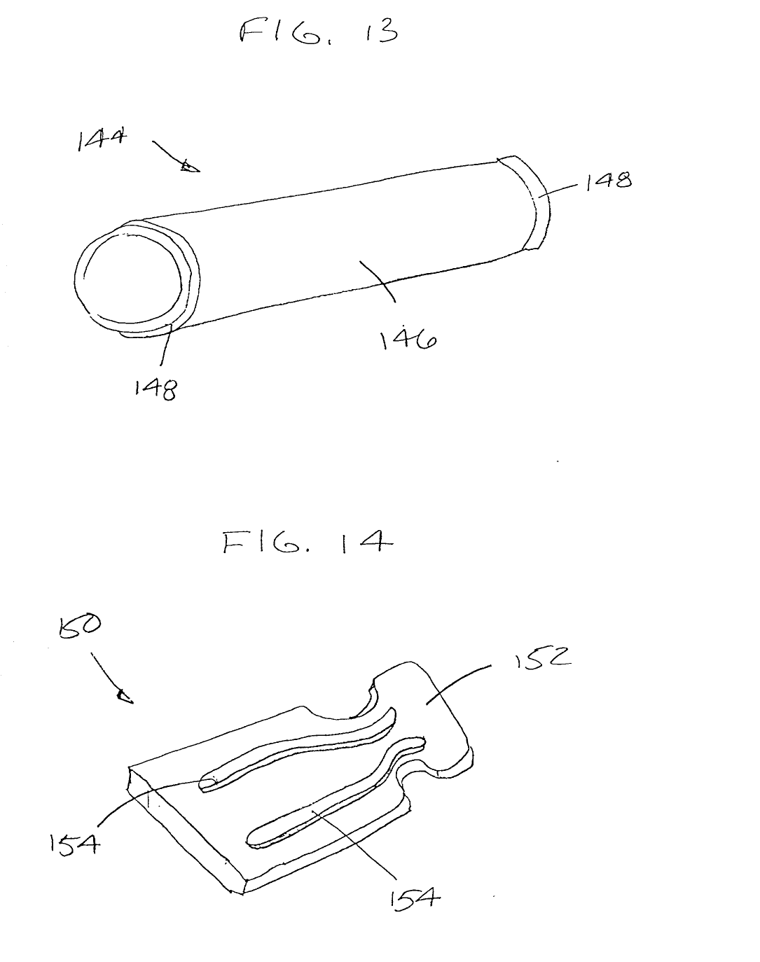

Referring now to FIG. 12, another application for the composite of the present invention is shown. In this application, a composite window 136 is formed by molding a layer of polyurethane 138 to a layer of transparent material 140, such as acrylic. As shown in FIG. 12, the transparent material 140 is visible through a rectangular opening 142 molded from the polyurethane. In this manner, the polyurethane may act as an integral seal for the window 136. However, it is also recognized that openings 142 having complex shapes may be formed utilizing this method to provide an improved seal and/or to enhance shock resistance for the window 136.

Referring now to FIG. 13, another application for the composite of the present invention is shown. In this application, a spring 144 is formed of a hollow cylinder of polyurethane 146 molded between a pair of end washers 148, which are manufactured of a non-stick material such as UHMW, Teflon® or the like. Such a spring 144 is an improvement over current polyurethane springs as the end washer 148 prevent binding of the polyurethane and allow the spring to rotate freely.

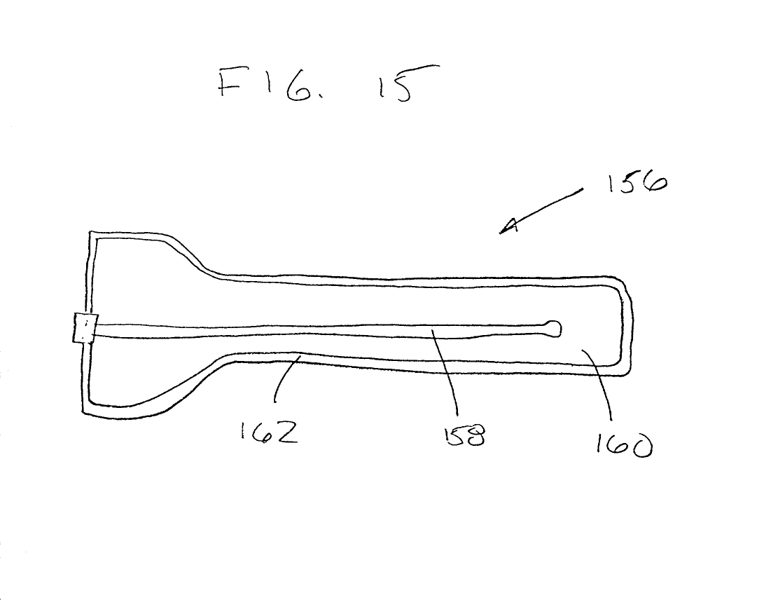

Referring now to FIG. 14, another application for the composite of the present invention is shown. In this application, a composite glass handling pad 150, commonly referred to as an A.V.N.S. pad, is formed by molding a pair of polyurethane layers 154 to a surface of a substantially rigid non-polar layer 152, manufactured of a material such as UHMW. In this arrangement, the abrasion resistant properties of the polyurethane layers 154 and the structural rigidity and low cost of the non-polar layer 152 offer improvements over glass handling pads 150 currently employed in the industry.

Referring now to FIG. 15, still another application for the composite of the present invention is shown. In this application, an antenna 156 is formed by encapsulating an electronic circuit 158 within a non-polar material 160, such as G10, and molding a polyurethane layer 162 over the entire surface of the non-polar material 160. In this manner, the polyurethane layer 162 provides enhanced corrosion resistance and thermal stability, while the non-polar material 160 imparts mechanical rigidity to the antenna 156.

It is noted, however, that the encapsulation of electronic circuit 158 within a non-polar material 160 and a polyurethane coating layer 162 is not limited to use in antennas. Rather, such a composite may be utilized in any circumstance where such a combination of properties is desired.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method of manufacturing a polyurethane composite material comprising the steps of:
forming a non-polar material into a predetermined shape;
preparing a bonding surface of said non-polar material by plasma treating said bonding surface;
positioning said non-polar material in a mold;
disposing liquid precursors of polyurethane into a cavity of said mold such that said liquid precursor of polyurethane is in contact with said bonding surface of said non-polar material; and
curing said liquid precursor of polyurethane to form a polyurethane material;
wherein said non-polar material and said polyurethane are effectively joined at said bonding surface of said non-polar material to form said polyurethane composite material.

2. The method as claimed in claim 1 wherein said step of preparing a bonding surface of said non-polar material comprises the steps of:
disposing said non-polar material between two electrodes in a vacuum chamber;
sealing said vacuum chamber;
discharging a plasma between said electrodes such that said bonding surface of said non-polar material is sufficiently modified to allow bonding of said polyurethane; and
removing said non-polar material from said vacuum chamber.

3. The method as claimed in claim 2 further comprising the steps of;
removing ambient air from said vacuum chamber; and
disposing a predetermined gas within said vacuum chamber before discharging said plasma.

4. The method as claimed in claim 1 wherein said non-polar material is ultra high molecular weight polyethylene.

5. The method as claimed in claim 1 further comprising the step of disposing a metallic material in a predetermined position in said mold, before said step disposing said liquid precursor of polyurethane in said mold, such that polyurethane effectively joins said non-polar material and said metallic material.

6. The method as claimed in claim 5 wherein said step of preparing a bonding surface of said non-polar material comprises the steps of:
disposing said non-polar material between two electrodes in a vacuum chamber;
sealing said vacuum chamber;
discharging a plasma between said electrodes such that said bonding surface of said non-polar material is sufficiently modified to allow bonding of said polyurethane; and
removing said non-polar material from said vacuum chamber.

7. The method as claimed in claim 6 further comprising the steps of;
removing ambient air from said vacuum chamber; and
disposing a predetermined gas within said vacuum chamber before discharging said plasma.

8. The method as claimed in claim 5 wherein said non-polar material is ultra high molecular weight polyethylene.
